(19) United States
(12) Patent Application Publication
(10) Pub. No.: US 2020/0286153 A1
(43) Pub. Date: Sep. 10, 2020

(54) INFORMATION RECOMMENDATION METHOD AND SERVER

(71) Applicant: SHENZHEN AVATAR CONTROLS CO., LTD., Shenzhen City, Guangdong Province (CN)

(72) Inventor: WEIHUA QIU, Changzhou City, Jiangsu Province (CN)

(21) Appl. No.: 16/763,979

(22) PCT Filed: Dec. 14, 2018
(86) PCT No.: PCT/CN2018/121284

§ 371 Date: May 13, 2020

(30) Foreign Application Priority Data
Jan. 24, 2018 (CN) 201810069445.3

(51) Int. Cl. G06Q 30/06; G06F 16/9535; G06Q 10/00; G06Q 10/10; A24F 40/60; A24F 40/65

(52) U.S. Cl. CPC G06Q 30/0631; G06F 16/9535; G06Q 30/0623; A24F 40/65; G06Q 10/109; A24F 40/60; G06Q 10/20

(57) ABSTRACT

An information recommendation method is provided. The method includes: acquiring smoking-related feature information of a user; obtaining product information of recommended products according to the smoking-related feature information; and sending the product information of the recommended products to a predetermined device, wherein the predetermined device includes an electronic cigarette and/or an electronic device. The method solves the problem in the related art that the user is prone to mistakenly purchase an electronic cigarette or an electronic cigarette accessory that does not meet his own needs, and accordingly, achieves the effect of guiding the user to select an electronic cigarette or an electronic cigarette accessory that meets his own needs.

### TECHNICAL FIELD

The present invention relates to the field of computer technologies, and in particular, to an information recommendation method and a server.

### BACKGROUND

An electronic cigarette is an electronic product that imitates cigarettes, which atomizes the e-liquid through an atomizer to generate smoke, which can be sucked by the user from the mouthpiece, thereby achieving the purpose of simulating smoking.

At present, when a user purchases an electronic cigarette or an electronic cigarette accessory such as atomizer, atomizing head, e-liquid, etc., the user needs to query the basic parameters of the electronic cigarette or the electronic cigarette accessory firstly through the Internet, and then chooses to purchase after analyzing according to these basic parameters. The user's operation is cumbersome and it is easy to cause mistaken purchase.

### SUMMARY

In order to solve the problem that a user is prone to mistakenly purchase an electronic cigarette or an electronic cigarette accessory that does not meet his own needs, an embodiment of the present invention provides an information recommendation method and a server. The technical solution is as follows:

In a first aspect, an information recommendation method is provided. The method includes:

acquiring smoking-related feature information of a user;

obtaining product information of recommended products according to the smoking-related feature information; and

sending the product information of the recommended products to a predetermined device, wherein the predetermined device comprises an electronic cigarette and/or an electronic device.

Optionally, sending the product information of the recommended products to a predetermined device includes:

obtaining a recommendation reason for the recommended products; and

sending the recommendation reason and the product information of the recommended products to the predetermined device.

Optionally, obtaining product information of recommended products according to the smoking-related feature information includes:

generating filter criteria according to the smoking-related feature information;

filtering out the recommended products from a plurality of candidate products according to the filter criteria; and

obtaining the product information of the recommended products.

Optionally, obtaining product information of recommended products according to the smoking-related feature information includes:

calculating the matching degree between the smoking-related feature information and the product information of each candidate product;

determining a predetermined number of candidate products with the highest matching degree as the recommended products; and

obtaining the product information of the recommended products.

Optionally, the method further includes:

acquiring a first account logged on the predetermined device;

querying a second account that has a friend relationship with the first account; and

obtaining the product information of a target product used by the user of the second account;

wherein sending the product information of the recommended products to a predetermined device includes:

sending the product information of the recommended products and the product information of the target product together to the predetermined device.

Optionally, if there are at least two pieces of product information of the target products, sending the product information of the recommended products and the product information of the target product together to the predetermined device includes:

calculating the matching degree between the smoking-related feature information and the at least two pieces of product information of the target products; and

sending the product information of the recommended products and the product information of the target products that are determined with the matching degree higher than a preset threshold together to the predetermined device.

Optionally, the method further includes:

acquiring the usage data of similar users according to the smoking-related feature information;

determining the recommended values of the working parameters according to the usage data of the similar users; and

sending a recommendation information carrying the recommended values to the predetermined device.

Optionally, the method further includes:

acquiring a first account logged on the predetermined device;

querying a second account that has a friend relationship with the first account;

obtaining the usage data corresponding to the second account;

determining the recommended values of the working parameters according to the usage data of the second account; and

sending a recommendation information carrying the recommended values to the predetermined device.

Optionally, before sending a recommendation information carrying the recommended values to the predetermined device, the method further includes:

determining whether the electronic cigarette supports the recommended values of the working parameters according to the product information of the electronic cigarette; and

performing the step of sending a recommendation information carrying the recommended values to the predetermined device if the electronic cigarette supports the recommended values of the working parameters.

Optionally, the method further includes:

acquiring the replacement information of an accessory in a plurality of other electronic cigarettes, wherein the replacement information includes the product information of the accessory, the usage information of the accessory, or the product information of the other electronic cigarettes in which the accessory is used;

determining whether the accessory in the electronic cigarette needs to be replaced according to the smoking-related feature information and the replacement information of the accessory; and

when the accessory in the electronic cigarette needs to be replaced, sending a reminder message to the predetermined device.

In a second aspect, a computer readable storage medium is provided. The computer readable storage medium stores therein one or more instructions, when the one or more instructions are executed by a processor in a server, the information recommendation method according to the first aspect and any one of the embodiments of the first aspect is implemented.

In a third aspect, a server is provided. The server includes:

a memory and a processor;

the memory storing at least one program instruction;

the processor loading and executing the at least one program instruction to implement the information recommendation method according to the first aspect and any one of the embodiments of the first aspect.

The beneficial effects brought by the technical solutions provided by the embodiments of the present invention are as follows:

The method acquires the smoking-related feature information of a user, obtains the product information of the recommended products according to the smoking-related feature information, and sends the product information of the recommended products to a predetermined device, wherein the predetermined device includes an electronic cigarette and/or an electronic device. The invention solves the problem in the related art that the user is prone to mistakenly purchase an electronic cigarette or an electronic cigarette accessory that does not meet his own needs, and accordingly, achieves the effect of guiding the user to select an electronic cigarette or an electronic cigarette accessory that meets his own needs.

### BRIEF DESCRIPTION OF THE DRAWINGS

In order to more clearly illustrate the technical solutions in the embodiments of the present invention, the drawings used in the description of the embodiments will be briefly described below. It is obvious that the drawings in the following description are only some embodiments of the present invention. For those of ordinary skill in the art, other drawings may also be obtained in light of these drawings without any creative efforts.

FIG. 1 is a schematic diagram of an implementation environment according to an exemplary embodiment of the present invention;

FIG. 2 is a flowchart of an information recommendation method according to an embodiment of the present invention.

### DETAILED DESCRIPTION OF PREFERRED EMBODIMENTS

The embodiments of the present invention will be further described in detail below with reference to the accompanying drawings. The “electronic devices” mentioned in the description may include smart phones, tablets, smart TVs, e-book readers, MP3 players (Moving Picture Experts Group Audio Layer III), MP4 (Moving Picture Experts Group Audio Layer IV) players, laptops and desktop computers, or the like.

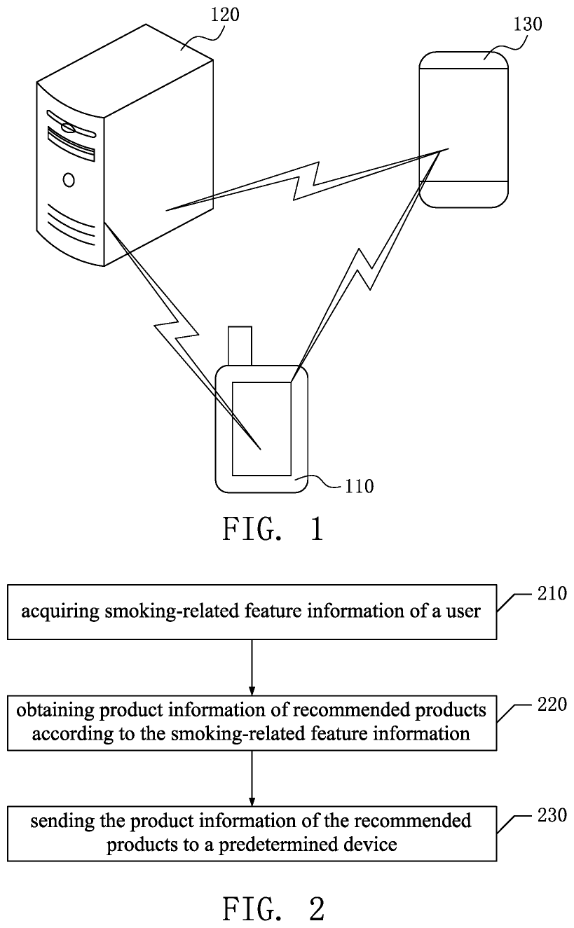

FIG. 1 is a schematic diagram of an implementation environment according to an exemplary embodiment of the present invention. The implementation environment includes an electronic cigarette 110 and a server 120. The server 120 may be a single server or a server cluster composed of multiple servers.

The electronic cigarette 110 and the server 120 may communicate in following two ways.

First, the electronic cigarette 110 may be connected to the server 120 via a wired or wireless network.

Second, the implementation environment further includes an electronic device 130 on which an application for providing product service to the electronic cigarette is installed, and the server 120 is a server that provides background service to the application.

In actual implementation, the electronic device 130 may be connected to the electronic cigarette 110 through a wireless communication technology, such as Bluetooth, NFC (Near Field Communication) or the like; the electronic device 130 is connected to the server 120 through a wired or wireless network.

Further, it should be noted that the predetermined device referred to in the present invention may include at least one of the electronic cigarette 110 and the electronic device 130 bound to the electronic cigarette 110.

Referring to FIG. 2, a flowchart of an information recommendation method is provided by an embodiment of the present invention. In this embodiment, the information recommendation method is illustrated as being applied in the server 120 shown in FIG. 1. As shown in FIG. 2, the information recommendation method may include:

Step 210: acquiring smoking-related feature information of a user.

The smoking-related feature information mentioned herein may include at least one of user basic information, usage data generated during use of the electronic cigarette, and product information of the electronic cigarette.

The usage data, the user basic information and the product information are described below, respectively.

First, the usage data mentioned herein is the usage data generated during use of the electronic cigarette, and may include at least one of a variety of data, such as, the use frequency of the electronic cigarette, the smoking frequency of the electronic cigarette, the duration of smoking each time, the number of puffs being sucked each time when the electronic cigarette is turned on, the output power set by the user of the electronic cigarette, the current output power of the electronic cigarette, the average output power of the electronic cigarette, the target temperature or the target temperature range set by the user in a temperature control mode of the electronic cigarette, the working period of the electronic cigarette, and the consumption rate of the e-liquid in the electronic cigarette.

The use frequency of the electronic cigarette may be the use frequency of the electronic cigarette in a statistical period, the smoking frequency of the electronic cigarette may be the frequency at which the electronic cigarette is smoked in a statistical period, wherein the statistical period may be set by the system developer. For example, the system developer can set one day or one week as a statistical period.

Taking one day as a statistical period to illustrate the use frequency of the electronic cigarette, if the electronic cigarette is turned on and off five times one day, and the electronic cigarette is smoked each time after it is turned on, then the electronic cigarette is confirmed as being used five times in the statistical period.

The electronic cigarette can detect whether it is smoked through the following manner, further obtaining information such as the number of puffs being sucked, the duration of smoking each time, or the like. Specifically, the electronic cigarette is provided with a sensor for detecting the airflow, and the sensor can be, for example, an air pressure sensor, an airflow sensor, a pressure sensor, or the like, used to detect the airflow. An airflow passage in which the sensor is disposed is communicated with a mouthpiece of the electronic cigarette. When the user sucks through the mouthpiece of the electronic cigarette, since the sensor is disposed in the airflow passage that is communicated with the mouthpiece, the sensor can detect the change of the airflow (e.g., the change of air pressure, the change of airflow velocity, etc.) in the airflow passage, so that it can determine whether the electronic cigarette is being smoked according to the change of the airflow.

The user can set the output power of the electronic cigarette in an example illustrated below. Specifically, the electronic cigarette may be provided with an increase button for increasing the output power and a decrease button for decreasing the output power. If the current output power is 35 W, when the electronic cigarette detects that the increase button is pressed, then the electronic cigarette adjusts its output power to 40 W, so that the atomizer of the electronic cigarette will work at 40 W, that is, the output power set by the user of the electronic cigarette is 40 W.

The working period of the electronic cigarette is illustrated in an example below. If the time turning on the electronic cigarette is recorded at 8:00, and the time turning off the electronic cigarette is recorded at 9:00 after turning on, then the working period of the electronic cigarette is 8:00 to 9:00.

Second, the user basic information of the user using the electronic cigarette may include at least one of the physiological information such as gender, age, age range, smoking age, or the like.

Further, the user basic information may be submitted by the user in a predetermined device. For example, the user can register a user account in the server 120 using an application of the electronic device 130 through the implementation environment shown in FIG. 1. During the registration process, the electronic device 130 may exhibit an input box for the user to input the user's basic information, and then submit the basic information of the user inputted in the input box to the server 120.

Third, the product information of the electronic cigarette may include, for example, at least one of product model, product type, brand, body color, rated power, battery capacity, resistance of the atomizing core, product size, adjustable range of output power, and output power.

Step 210 can be implemented in the following ways.

First, in the case that the electronic cigarette can be directly connected to the server through a wired or wireless network, the electronic cigarette transmits the smoking-related feature information to the server, and the server receives the smoking-related feature information sent from the electronic cigarette.

In actual implementation, the electronic cigarette sends the smoking-related feature information together with its device identifier to the server; or the electronic cigarette obtains the user account logged in, and sends the smoking-related feature information together with the user account to the server.

Second, when the electronic cigarette is connected to the electronic device bound with the electronic cigarette through wireless communication technology, the electronic cigarette can send the smoking-related feature information to the electronic device, and then the electronic device uploads the smoking-related feature information to the server.

In actual implementation, the server may perform step 220 according to the smoking-related feature information provided by the electronic cigarette, and send the obtained product information to the electronic cigarette and/or to the electronic device bound with the electronic cigarette. The server may also perform step 220 according to the smoking-related feature information provided by the electronic cigarette bound to the user account, and then send the obtained product information to the electronic device that logs on the server using the user account and/or to the electronic cigarette bound with the user account.

Step 220: obtaining product information of recommended products according to the smoking-related feature information.

This step can be achieved in the following ways.

First, filter criteria are generated according to the smoking-related feature information, so that the recommended products are filtered out from a plurality of candidate products according to the filter criteria. Then, the product information of the recommended products is obtained.

The candidate products may be electronic cigarettes or electronic cigarette accessories that are already sold on the market, or may be electronic cigarettes or electronic cigarette accessories that are newly sold on the market, or may also be electronic cigarettes or electronic cigarette accessories determined according to the user's historical search records. For an example, if the user has searched electronic cigarettes of brand A on the electronic device, then the candidate products may include all the electronic cigarettes of brand A; for a further example, if the user has searched electronic cigarettes of brand A with model B on the electronic device, then the candidate products may include all the electronic cigarettes of brand A with model B.

The specific implementation may be as follows: a plurality of candidate filter criteria are preset in the server, with each candidate filter criterion corresponding to a use condition; after receiving the smoking-related feature information, the server obtains the use conditions corresponding to all of the candidate filter criteria, and determines whether the smoking-related feature information satisfies each of the use conditions; the candidate filter criteria with the use conditions satisfied are determined as the filter criteria.

For example, a candidate filter criterion preset in the server may be: an upper limit value of the adjustable range of output power is less than 30 W. The use condition corresponding to this candidate filter criterion may be: an average value of the output power of the electronic cigarette is not higher than 25 W. Then, when the smoking-related feature information indicates that the average value of the output power of the electronic cigarette is not higher than 25 W, the server sets the upper limit value of the adjustable range of output power to be less than 30 W as a filter criterion.

Second, the matching degree between the smoking-related feature information and the product information of each candidate product is calculated; the predetermined number of candidate products with the highest matching degree are determined as the recommended products; and the product information of the recommended products is obtained.

The predetermined number may be set by the system developer or may be set by the user in the predetermined device.

For example, if the adjustable range of output power included in the smoking-related feature information is [20 w, 35 w], and the adjustable range of output power of a candidate product is [20 w, 45 w], then the overlap area between [20 w, 45 w] and [20 w, 35 w] is [20 w, 35 w]; the overlap ratio of the overlap area [20 w, 35 w] and the adjustable range of output power (i.e., [20 w, 35 w]) in the smoking-related feature information is calculated to be 100%, so that the matching degree is 100%.

Third, electronic cigarettes (or electronic cigarette accessories) used by similar users are obtained according to the user basic information in the smoking-related feature information; the electronic cigarettes (or electronic cigarette accessories) with the highest use frequency are determined as the recommended products; then, the product information of the recommended products is obtained.

The similar users herein refer to a plurality of users having at least one common smoking-related feature information, that is, at least one of the smoking-related feature information from the similar users is the same or similar. For example, the similar users may be the users having the same age, and/or having the same age group, and/or having the same length as a smoker, and/or using electronic cigarettes with the same product model.

Fourth, the product series of the electronic cigarette are determined according to the product model of the electronic cigarette; the latest electronic cigarettes within the product series are obtained; the latest electronic cigarettes within the product series are determined as the recommended products; and the product information of the recommended products is obtained.

The latest electronic cigarettes within each product series are set by the system developer.

Step 230: sending the product information of the recommended products to a predetermined device.

The implementation of this step may further be: obtaining a recommendation reason for the recommended products; and sending the recommendation reason and the product information of the recommended products to the predetermined device.

The recommendation reason for the recommended products may be a fixed text set by the system developer, for example, “a most suitable product is recommended for you according to your smoking habit”. Optionally, the recommendation reason may be generated by the server based on the smoking-related feature information, the specific implementation may be: the server uses the filter criteria to generate the recommendation reason, or the server generates the recommendation reason by using the product information of the recommended products.

For example, if the filter criterion is that the upper limit value of the adjustable range of output power is less than 30 W, the recommendation reason may be: when you use an electronic cigarette, you like small smoke, so it is recommended that you use electronic cigarettes with the upper limit value of the adjustable range of output power being less than 30 W, such electronic cigarettes will produce less smoke.

In summary, the method provided by the embodiment of the present invention acquires the smoking-related feature information of a user, obtains the product information of the recommended products according to the smoking-related feature information, and sends the product information of the recommended products to a predetermined device, wherein the predetermined device includes an electronic cigarette and/or an electronic device. The invention solves the problem in the related art that the user is prone to mistakenly purchase an electronic cigarette or an electronic cigarette accessory that does not meet his own needs, and accordingly, achieves the effect of guiding the user to select an electronic cigarette or an electronic cigarette accessory that meets his own needs.

In an example, the user may further be reminded to prepare an alternate electronic cigarette accessory in advance by the following ways: acquiring the replacement information of an accessory in a plurality of other electronic cigarettes, wherein the replacement information includes the product information of the accessory, the usage information of the accessory, or the product information of the other electronic cigarettes in which the accessory is used; determining whether the accessory in the electronic cigarette needs to be replaced according to the smoking-related feature information and the replacement information of the accessory; and when the accessory in the electronic cigarette needs to be replaced, sending a reminder message to the predetermined device.

The usage information of the accessory may be the usage duration or the number of usage times of the accessory.

For example, the replacement information of an accessory in a plurality of electronic cigarettes is acquired, wherein the accessory is an atomizer and the replacement information includes the product model of the atomizer, the usage duration of the atomizer, and the product models of the electronic cigarettes in which the atomizer is used; and it is calculated that the average usage duration of an atomizer with model A in an electronic cigarette with model B is 50 days according to the replacement information. Then, if the smoking-related feature information submitted to the server by an electronic cigarette with model B indicates that the atomizer with model A in the electronic cigarette has been used for 50 days, then the server sends a reminder message to the predetermined device. The reminder message may be used to remind the user that the service life of the atomizer B will reach the limit in the near future, so that the user is reminded to prepare an atomizer in advance for replacement; and the reminder message may also be used to remind the user to replace the atomizer B as soon as possible to avoid affecting the user's smoking experience.

In an example, the working parameters of the electronic cigarette can further be recommended to the user in the following ways.

First, the usage data of the similar users are acquired according to the smoking-related feature information; the recommended values of the working parameters are determined according to the usage data of the similar users; and a recommendation information carrying the recommended values is sent to the predetermined device.

The working parameters mentioned herein may include at least one of the use frequency of the electronic cigarette, the smoking frequency of the electronic cigarette, the duration of smoking each time, the number of puffs being sucked each time when the electronic cigarette is turned on, the output power set by the user of the electronic cigarette, the current output power of the electronic cigarette, the average output power of the electronic cigarette, the target temperature or the target temperature range set by the user in a temperature control mode of the electronic cigarette, the working period of the electronic cigarette, and the consumption rate of the e-liquid in the electronic cigarette.

The recommended values of the working parameters are determined according to the usage data of the similar users, which can be implemented in the following two ways:

First, acquiring the value of each working parameter of the user of the electronic cigarette and the similar users; calculating the average value of each working parameter of the user of the electronic cigarette and the similar users, and obtaining the recommended value of each working parameter.

Second, acquiring the value of each working parameter of the user of the electronic cigarette and the similar users, and selecting the value with the highest use frequency as the recommended value of each working parameter.

Second, acquiring a first account logged on the predetermined device, querying a second account having a friend relationship with the first account, obtaining the usage data corresponding to the second account, determining the recommended values of the working parameters according to the usage data of the second account, and sending a recommendation information carrying the recommended values to the predetermined device.

For the implementation of determining the recommended values of the working parameters according to the usage data of the second account, reference can be made to the implementation of determining the recommended values of the working parameters according to the usage data of the similar users, and details are not described herein again.

Further, before recommending the recommended values of the working parameters to the user of the electronic cigarette, the following steps may be performed: determining whether the electronic cigarette supports the recommended values of the working parameters; if the electronic cigarette supports the recommended values of the working parameters, then performing the step of sending the recommendation information carrying the recommended values to the predetermined device.

For example, if the recommended value of the output power determined by the server is 35W, and the output power of the electronic cigarette can be adjusted from 20 W to 30 W, it indicates that the electronic cigarette does not support the output power of 35 W, so that the server does not send the recommendation information carrying the recommended value of the output power being 35 W to the predetermined device.

For another example, if the recommended value of the output power determined by the server is 35 W, and the output power of the electronic cigarette can be adjusted from 20 W to 40 W, it indicates that the electronic cigarette supports the output power of 35 W, so that the server sends the recommendation information carrying the recommended value of the output power being 35 W to the predetermined device.

In an example, after receiving the recommendation reason comprised of the filter criteria, the predetermined device displays an editing interface including the filter criteria; the user may add or modify or delete the filter criteria in the editing interface, and the predetermined device sends the filter criteria confirmed by the user in the editing interface to the server; the server then re-determines new recommended products according to the filter criteria confirmed by the user; the product information of the new recommended products is sent to the predetermined device.

In an example, in addition to sending the product information of the recommended products to the predetermined device, the following steps may also be included:

(1) acquiring a first account logged on the predetermined device, and querying a second account that has a friend relationship with the first account;

(2) obtaining the product information of a target product used by the user of the second account. Optionally, the product information of the target product may be the product information of an electronic cigarette bound to the second account, and details are not described herein again. Of course, in actual implementation, the product information of the target product may also be the product information of an electronic cigarette browsed by the user of the second account.

Correspondingly, the step of sending the product information of the recommended products to the predetermined device in the above steps includes:

sending the product information of the recommended products and the product information of the target product together to the predetermined device.

By sending the product information of the target product to the predetermined device while sending the product information of the recommended products to the predetermined device, the user can not only view from the predetermined device the product information of the products that meets his own usage habits, but also can view the product information of the products used by his friends. Since the products used by the user's friends are likely to be the products of the user's own interest, the above method is more comprehensive for the products recommended to the user.

In addition, in the foregoing method, since there may be multiple second accounts having a friend relationship with the first account, and there may be multiple target products used by the user of each second account, there may be at least two pieces of product information of the target products obtained in the above method. At this time, when the server sends the product information to the predetermined device, the server may send all of the at least two pieces of product information to the predetermined device. Of course, if the pieces of product information sent to the predetermined device by the server is limited, then the pieces of product information of the target products can be determined according to the pieces of product information of the recommended products, and only the determined pieces of product information of the target products are sent to the predetermined device. After the pieces of product information of the target products that needs to be sent are determined, the matching degree between the user's smoking-related feature information and the at least two pieces of product information of the target products may be calculated, and then the product information of the target products with the top N matching degree is sent to the predetermined device, wherein N refers to the pieces of product information of the target products as determined above. Also, the server can directly send the product information of the target products with the matching degree higher than a preset threshold to the predetermined device, and further details are not provided herein again.

An embodiment of the present invention further provides a computer readable storage medium. One or more instructions are stored in the computer readable storage medium, wherein when the one or more instructions are executed by a processor in a server, the information recommendation method in any of the above embodiments is implemented.

The server in the present invention may include a processor and a memory, and the processor is used for executing computer program instructions to perform various processes and methods. The memory is used for storing at least one program instruction, and the processor, by executing the at least one program instruction, implements the information recommendation method in any of the above embodiments.

The serial numbers in the embodiments of the present invention are merely for the description, and do not represent the advantages and disadvantages of the embodiments.

A person skilled in the art may understand that all or part of the steps of implementing the above embodiments may be completed by hardware, or may be instructed by a program to instruct related hardware, and the program may be stored in a computer readable storage medium. The storage medium mentioned may be a read only memory, a magnetic disk, an optical disk or the like.

The above are only the preferred embodiments of the present invention, and are not intended to limit the present invention. Any modifications, equivalents, improvements, etc., which are within the spirit and scope of the present invention, should be included in the protection scope of the present invention.

1. An information recommendation method, comprising:
acquiring smoking-related feature information of a user;
obtaining product information of recommended products according to the smoking-related feature information; and
sending the product information of the recommended products to a predetermined device, wherein the predetermined device comprises an electronic cigarette and/or an electronic device.

2. The method according to claim 1, wherein said sending the product information of the recommended products to a predetermined device comprises:
obtaining a recommendation reason for the recommended products; and
sending the recommendation reason and the product information of the recommended products to the predetermined device.

3. The method according to claim 1, wherein said obtaining product information of recommended products according to the smoking-related feature information comprises:
generating filter criteria according to the smoking-related feature information;
filtering out the recommended products from a plurality of candidate products according to the filter criteria; and
obtaining the product information of the recommended products.

4. The method according to claim 1, wherein said obtaining product information of recommended products according to the smoking-related feature information comprises:
calculating the matching degree between the smoking-related feature information and the product information of each candidate product;
determining a predetermined number of candidate products with the highest matching degree as the recommended products; and
obtaining the product information of the recommended products.

5. The method according to claim 1, wherein the method further comprises:
acquiring a first account logged on the predetermined device;
querying a second account that has a friend relationship with the first account; and
obtaining the product information of a target product used by the user of the second account;
wherein said sending the product information of the recommended products to a predetermined device comprises:
sending the product information of the recommended products and the product information of the target product together to the predetermined device.

6. The method according to claim 5, wherein if there are at least two pieces of product information of the target products, said sending the product information of the recommended products and the product information of the target product together to the predetermined device comprises:
calculating the matching degree between the smoking-related feature information and the at least two pieces of product information of the target products; and
sending the product information of the recommended products and the product information of the target products that are determined with the matching degree higher than a preset threshold together to the predetermined device.

7. The method according to claim 1, wherein the method further comprises:
acquiring the usage data of similar users according to the smoking-related feature information;
determining the recommended values of the working parameters of the electronic cigarette according to the usage data of the similar users; and
sending a recommendation information carrying the recommended values to the predetermined device.

8. The method according to claim 1, wherein the method further comprises:
acquiring a first account logged on the predetermined device;
querying a second account that has a friend relationship with the first account;
obtaining the usage data corresponding to the second account;
determining the recommended values of the working parameters of the electronic cigarette according to the usage data of the second account; and
sending a recommendation information carrying the recommended values to the predetermined device.

9. The method according to claim 7, wherein before said sending a recommendation information carrying the recommended values to the predetermined device, the method further comprises:
determining whether the electronic cigarette supports the recommended values of the working parameters according to the product information of the electronic cigarette; and
performing the step of sending a recommendation information carrying the recommended values to the predetermined device if the electronic cigarette supports the recommended values of the working parameters.

10. The method according to claim 1, wherein the method further comprises:
acquiring the replacement information of an accessory in a plurality of other electronic cigarettes, wherein the replacement information comprises the product information of the accessory, the usage information of the accessory, or the product information of the other electronic cigarettes in which the accessory is used;
determining whether the accessory in the electronic cigarette needs to be replaced according to the smoking-related feature information and the replacement information of the accessory; and
when the accessory in the electronic cigarette needs to be replaced, sending a reminder message to the predetermined device.

11. A computer readable storage medium having stored therein one or more instructions, wherein when the one or more instructions are executed by a processor in a server, the information recommendation method according to claim 1 is implemented.

12. A server, comprising:
a memory and a processor;
the memory storing at least one program instruction;
the processor loading and executing the at least one program instruction to implement the information recommendation method according to claim 1.
